(19) United States
(12) Patent Application Publication
(10) Pub. No.: US 2018/0337617 A1
(43) Pub. Date: Nov. 22, 2018

(54) PERPETUAL MAGNETOELECTRIC ENERGY DIRECT CURRENT POWER SUPPLY

(71) Applicant: Kenneth A. Gulliver, Brooklyn, NY (US)

(72) Inventor: Kenneth A. Gulliver, Brooklyn, NY (US)

(21) Appl. No.: 15/597,142

(22) Filed: May 16, 2017

(51) Int. Cl. H02N 11/00; H02K 53/00

(52) U.S. Cl. CPC H02N 11/008; H02K 53/00

(57) ABSTRACT

The system provides for the transformation of permanent magnetic energy into a continuous electric energy current flow within a circuit. This is accomplished by creating a very strong egg shaped planetary permanent magnet. The magnet contains a longitudinal channel through its center to allow for initial energization. The initial energization is accomplished by applying a very strong burst of electrical current from a direct current power source. The magnet embodying the present invention is an egg shaped object that shall be held in one place without any physical or visible rotation of the magnet itself. Instead, the egg shape of the magnet creates varying field strengths patterns for energy transfer and polarization due to the internal left hand rule principles of electric current. This arrangement will create a permanent or near permanent perpetuating magnetic field. This magnetic field maintains intrinsic, centripetal, magnetic forces that create a magnetic whirl-pool that rotates the magnetic field within the magnet without rotating the magnet itself. The system created by the present invention is capable of self-sufficiency, recharging itself through power flow in the system's circuit. Additionally, the power is supplemented with atmospheric energy seeking termination, or moving towards the magnet, due to the centripetal forces generated by the magnetic angular momentum depression inside the magnet.

### FIELD OF THE INVENTION

The present invention relates to the field of magneto-electricity, in particular, to a method of supplying energy through the use of magnets and a device applying said method.

### BACKGROUND OF THE INVENTION

Artificial source of power has been the driving force behind everything made by humans and has been the one single element that propelled humanity from the dark ages into modern times. The term “artificial” in this context denotes mechanical power derived from fuel, with one such fuel being electricity. However, as with all fuels, the production of electricity requires an investment of considerable production costs.

Electricity is perceived as the ideal fuel of the future. Since its discovery some 150 years ago, electricity generation and usage has become an increasingly sophisticated and efficient process. For example, over the last several years, while the use of electrical machinery has been increasing, as it has been ever since electricity was discovered, the demand for electricity itself has been slowing down.

As much as electromagnetic science has advanced the notion of efficient generation of electric current, the production of electricity still requires considerable investment of other fuel and resources. While some of these resources are renewable, such as water and air, the cost of electric generation remains significant. Therefore, there is a tremendous need for a device that will reduce the cost of producing electricity, or which will make the existing electrical charge go further. A device that fulfills this purpose is embodied in the present invention.

The present invention has the potential to propel humanity toward nearly autonomous or even passive energy generation by creating a nearly ideal efficiency electricity generation system. The system embodied by the present invention in ideal settings only requires initial energization in order to promote and maintain a self-sustaining electric charge. Practically speaking, the system requires an initial activation shock from an existing power source and periodic secondary electric shocks to maintain the flow of current. However, the built in efficiency of the system reduces the shock requirements to a near standby mode, where the secondary shock requirement is never used if the system equilibrium remains constant.

### SUMMARY OF THE INVENTION

The apparatus disclosed in the present invention transforms magnetic energy into a continuous electric energy current flow within a circuit. This is accomplished by creating a very strong magnet in the shape of an egg. In this shape the north and south poles of the magnet are complete coaxial with the flow channel of electric current traveling on a wire through the center of the magnet. The magnet contains a longitudinal channel through its center to allow for initial energization. The initial energization is accomplished by applying a very strong burst of electrical current from a direct current power source.

The magnet embodying the present invention is an egg shaped object that is inserted within the existing battery terminals. While the magnetic field inside the magnet is constantly spinning, the magnetic object itself remains immobile. The egg shape of the magnet creates a gradual increasing magnetic field originating from the pointed end of the egg and increasing in strength up until the blunt end, with the strength of the electric current in direct proportion to the magnetic field. The magnetic field inside the magnet and the flow of the current exist on the same axis, thus the flux naturally surrounding the flow of current is augmented by the magnetic field, which without any resistance inside the magnet, initiates an internal centripetal rotation giving rise to a specific one directional centripetal flow of electrons or the left hand rule principle. This centripetal motion creates an electromagnetic depression inside the magnet, which then attracts free electrons from the surrounding atmosphere towards the magnet, thus enhancing the magnet field and recover some of the energy lost by the magnet in maintaining voltage on the circuit. This arrangement will create a permanent or near permanent perpetuating magnetic field. This magnetic field maintains intrinsic, centripetal, magnetic forces that create a magnetic whirl-pool that rotates the magnetic field within the magnet without rotating the magnet itself.

The initial energization is accomplished by passing a wire through the longitudinal channel of the magnet. The wire, made from a highly conductive materials, for example copper, is then charged from a secondary power source, which may be a battery standby, or any other source of direct current. When sufficient wattage is reached to create a self-sustaining or near self-sustaining magnetic field within the magnet, the source of direct power source is disabled or removed. At that point the desired current is produced by the magnet itself. Furthermore, the current flowing through the wire carries on the dual role of delivering electric current to a load source and maintaining the rotation of the centripetal forces within the magnet.

To increase the wattage or power, the magnet embodied in the present invention may be increased by either increasing the size of the magnet, or by connecting one or more magnets in a row, with the energization wire running through the center of each magnet. The strength of electric current or voltage running on the wire is directly proportional to the number of magnets housed on the wire.

It is an object of the present invention to create a super-efficient power generating electric system.

It is another object of the present invention to create a self-recharging power generating electric system.

It is still another object of the present invention to turn a rare earth magnet or a magnetized material into a battery through introduction of a particular shape and linkage of the magnet.

It is still another object of the present invention to create an electric system that optimizes the efficiency of electric transfer through shape and configuration of its components.

### BRIEF DESCRIPTION OF THE DRAWINGS

FIG. 1A is a diagram demonstrating the utility of the present invention.

FIG. 1B is a diagram demonstrating the magnetic vortex occurring inside the magnet embodied in the present invention.

FIG. 1C is a diagram demonstrating several magnets that are chain linked to enhance the flow of electric power.

FIG. 2 is a demonstration of the initial charge or shock device.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

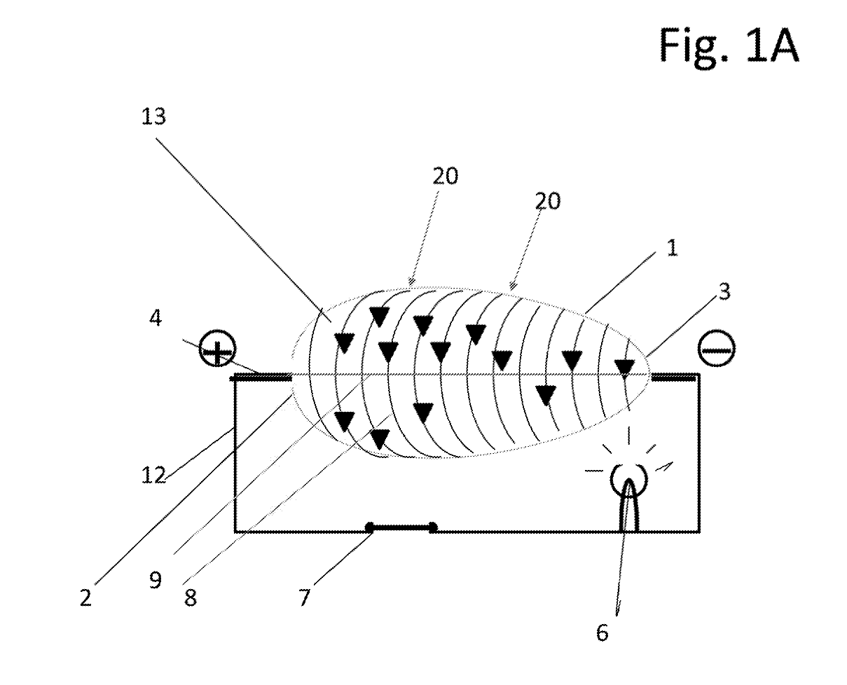

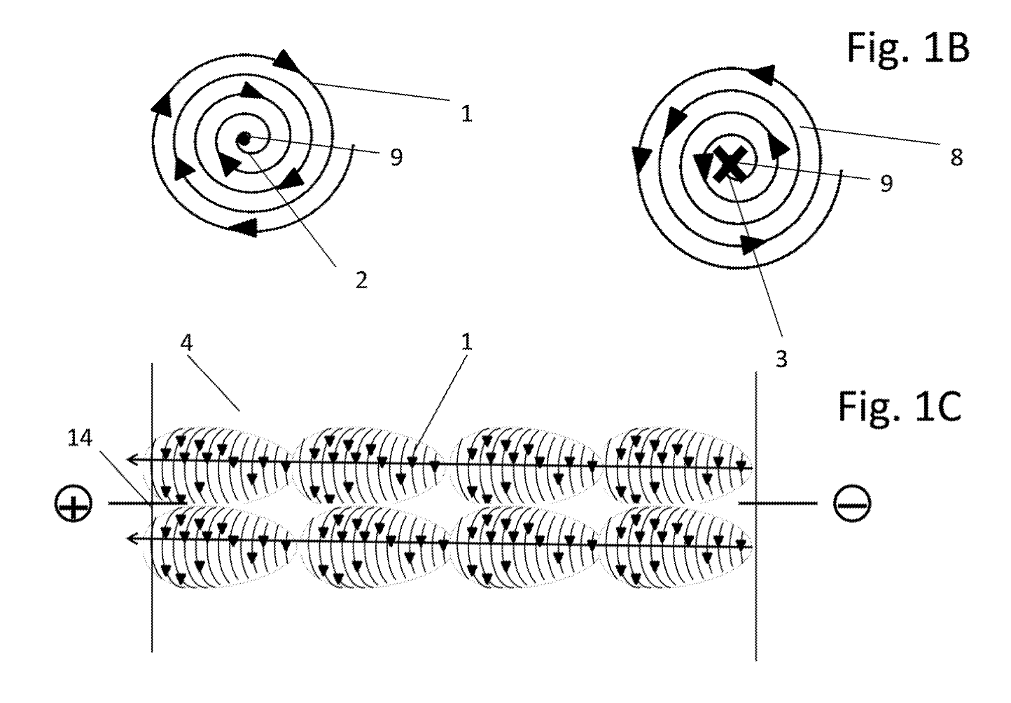

Turning now descriptively to the drawings, in which similar reference characters denote similar elements throughout the several views, the figures illustrate a perpetual or nearly perpetual permanent magnetic energy system showing in the FIG. 1A the magnet 1, the longitudinal channel 9, the forward section 3, the rear section 2, the magnetic field 8, the wire 4, the load 6, the switch 7, the length 10 and the width 11.

The magnet 1 may be made from an alloy combining several highly ferromagnetic conducive metals, or elements known to possess natural magnetism, such as copper, iron, nickel, aluminum, cobalt or titanium. The preferred length 10 of the magnet 1 may be between six and twelve inches, with the preferred width 11 being between four and eight inches, respectively. The egg shape serves as a guide for the magnetic field spin vertex 8. The infinite molecular magnetic domains will angle themselves and maintain a consistent pattern after the initial polarization. The electric current 12 creates the magnetic field 8 with initial energization. The magnetic field 8 will spin counterclockwise, with a natural inclined bias toward the current 12, as shown. The electric current 12 leads the rotating magnetic force 8, resulting in a natural concave acute shape (parabola) around the conducting wire, law of driven motion.

The magnet 1 that embodies the present invention has a small diameter, representing about one third of the magnet's overall width 11, at the point of current inflow, which is the front section 2. The diameter gradually increases gradually, until a point 13 that is approximately three forth of the distance to the rear section 2. At point 13, the preferred width of the magnet 1 is approximately eight inches, which must be kept proportional to the length 10. The diameter is then reduced precipitously until it reaches the rear section 2, which is also the area of the electron outflow, or the plus section or terminal. This design provides for the difference in magnetic field strength, with small diameter having a weaker magnet field flowing toward the larger diameter and stronger magnetic field, thus directing the flow of current 12 based on the principle of internal centripetal magnetic angular momentum vectorism. The measurements as shown in the diagram are 12″ length 10, and 8″ width (diameter) 11. Those dimensions making the magnet 1 into an egg shape. These dimensions may be increased or reduced for larger or smaller device sizes, respectively. For example, the length 10 may be 24″ and the width 11 at 16″, or length 6″ by width 5″. The magnet 1 has no energy loss due to resistance, since there is no rotation and the magnetic field resides inside the device. The direction of magnetic and electric energy fields flow to produce a perfect synergy for coaxial transmission of power.

The magnetic field 8 within the magnet 1 originates at longitudinal channel 9 and is then distributed in an arch confirming to the curvature of the sidewall 18, and eventually refracting centripetally to create a magnetic vortex shown in FIGS. 1A and 1B. The longitudinal channel 9 runs through the center of the magnet 1 and carries a highly conductive wire 4. The wire 4 represents a circuit that may have a switch 7 and a load 6, which is shown here as a simple light bulb, but which understandable may mean any other device requiring electricity to function.

The left hand principal stated above, creates a flow of current toward the rear end 2 of the magnet 1. The angular momentum of the centripetal force 8 in the magnet 1 functions to create an atmospheric depression within the magnet 1 where the atmospheric pressure 20 surrounding the magnet 1 is higher than within the magnet, causing the electrons of atmospheric molecules surrounding the magnet 1 to transfer their electrons to the magnet 1. This transfer of electrons partially offsets the loss of electric charge of the magnet 1 due to the resistor 6. Therefore, the magnet 1 is constantly recharged from two sources, the energized wire within the longitudinal channel 9 and from electrons given off by atmosphere 20.

FIG. 1C demonstrates that present invention in an alternative configuration. The configuration shown contains four magnets 1 connected in a series, on the same wire 4 that is traversing each magnet 1 through the longitudinal channel 9 of that magnet 1, thus multiplying the voltage by a factor of four. While the magnets 1 are shown as stringed in a single file any other configuration achieving the same result is anticipated. In FIG. 1C, four additional magnets 1 are connected on a separate wire 4. The wires are then connected through crossings 14. The side-by-side pairing of the magnets 1c and 1b creates a parallel connection between adjoining magnets 1c and 1b, increasing the amperage by a factor of four.

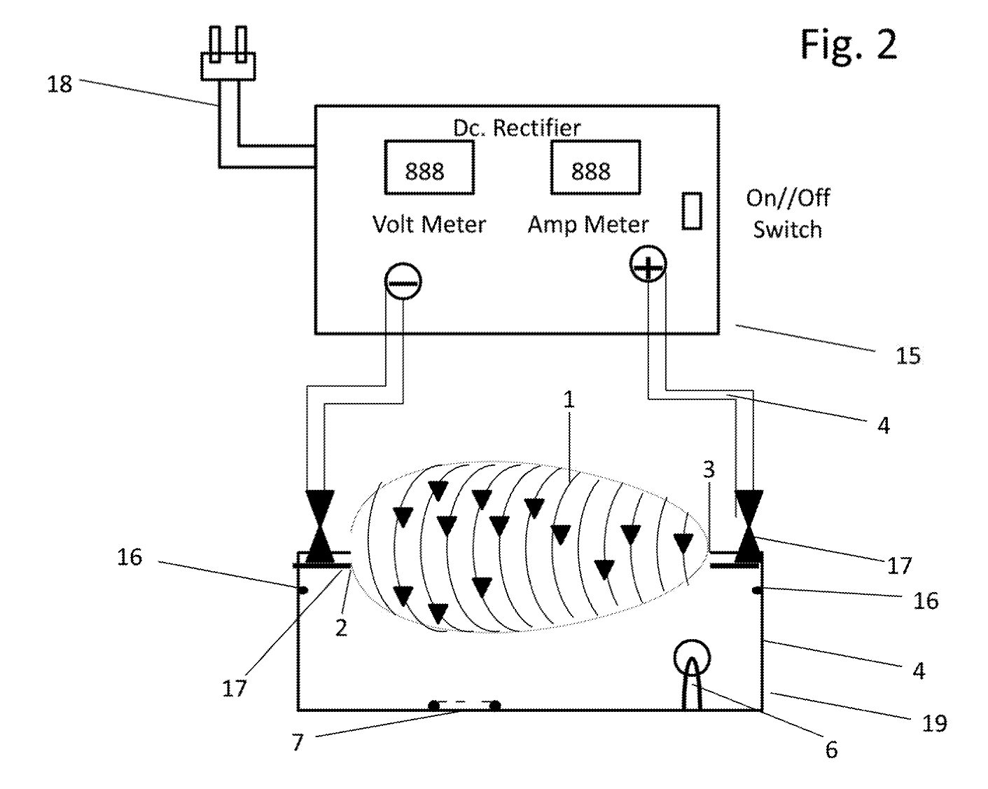

FIG. 2 demonstrates the present invention in the middle of the initial energizing stage. Shown is the magnet 1, the wire 4, the source of the direct current 15, the source of the alternating current 18 and a load device 19. The alternating current 18 is the assumed way by which electricity is delivered over long distances. This current must first be converted to direct current by the rectifier shown as device 15. The current is then applied to the magnet 1, to energize it. The load device 19 is shown in a disconnected state at points 16, which may be male female connectors or clamps, and with clamps 17 for coupling with magnet 1. Once the magnet 1 has been energized, the clamps 17 are removed, and points 16 are coupled to the magnet 1. Alternatively, the clamps 17 and connection points 16 may be connected together through a switch which can switch the circuit from energizing mode to a sustaining mode. In sustaining mode, as shown in FIG. 1A, the magnet 1 is placing an electrical current 12 to the load 7, while also taking the remaining current at point 2 to re-energize itself. The sustaining circuit is arranged in such a manner so as to require only so much current for the load as can be produced by the magnet-vortex occurring inside the magnet 1 after energization. The embodiment of the present invention shown in the figures is capable of achieving a perfect equilibrium of electron inflow and outflow. However, if a perfect equilibrium cannot be achieved, the magnet 1 will require periodic re-energization, thus requiring an occasional re-energization of the magnet 1. The occasional re-energization may be governed by a voltmeter monitoring the current outflow on the rear end 2, and causing the toggle switch between the direct current source and the load to switch to the direct current source, which may also be done in parallel to the load circuit 19.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A sustainable circuit comprising: a magnetic object having a forward end and a rear end; a longitudinal channel passing through said magnetic object between said forward and said rear ends; an energizing wire passing through said longitudinal channel; a magnetic field being present within said magnetic object, wherein said magnetic field increasing in the direction from said forward end toward said rear end; and wherein said magnetic object placing an electric current on said energizing wire to power a load.

2. The sustainable circuit of claim 1, wherein a diameter of said forward end is equal to a diameter on said rear end, wherein a sidewall of said magnetic object being curved and having gradually increasing diameter until a point three fourth of the distance between said forward end and said rear end and wherein diameter of said sidewall decreasing sharply from said point until said rear end, wherein diameter of said rear end being equal to diameter of said forward end, wherein said dimensions create an egg shaped elliptical object.

3. The sustainable circuit of claim 2, further comprising an energizing source, said energizing source temporarily coupled to said magnetic object, wherein an electric current from said energizing source is utilized to initiate said magnetic field.

4. The sustainable circuit of claim 3, wherein said energizing source and said load are connected to said magnetic object through a switch.

5. The sustainable circuit of claim 2, wherein said egg shaped elliptical object is capable of creating centripetal forces leading to an atmospheric depression, said atmospheric depression causing electrons surrounding said magnetic object to be attracted to said magnetic object thus increasing the magnitude of said magnetic field.

6. The sustainable circuit of claim 2, further comprising at least one additional magnetic object, said one additional magnetic object connected to said energizing wire; and wherein said electric current flowing on said energizing wire is increased in direct proportion to the current output produced by said one additional magnetic object.

7. The sustainable circuit of claim 4, further comprising at least one additional magnetic object, said one additional magnetic object connected to said energizing wire; and wherein said electric current flowing on said energizing wire is increased in direct proportion to the current output produced by said one additional magnetic object.

8. The sustainable circuit of claim 5, further comprising at least one additional magnetic object, said one additional magnetic object connected to said energizing wire; and wherein said electric current flowing on said energizing wire is increased in direct proportion to the current output produced by said one additional magnetic object.

9. The sustainable circuit of claim 1, wherein said magnetic object is manufactured from a group of materials comprising natural magnetism, copper, iron, nickel, aluminum, cobalt, titanium or any combination thereof.

10. The sustainable circuit of claim 2, wherein said magnetic object may have dimensions between 5 inches for width and 6 inches for a length.

11. The sustainable circuit of claim 1, wherein said magnetic object may have dimensions between 8 inches for width and 12 inches for a length.

12. The sustainable circuit of claim 2, wherein the ratio between a width and a length of said magnetic object is between 0.67 and 0.83.
